(19) United States
(12) Patent Application Publication
(10) Pub. No.: US 2015/0177958 A1
(43) Pub. Date: Jun. 25, 2015

(54) PROVIDING CONTEXT INFORMATION RELATING TO MEDIA CONTENT THAT IS BEING PRESENTED

(71) Applicant: Apple Inc., Cupertino, CA (US)

(72) Inventor: Matthew M. Hanlon, San Jose, CA (US)

(21) Appl. No.: 14/634,602

(22) Filed: Feb. 27, 2015

Related U.S. Application Data
(62) Division of application No. 13/070,697, filed on Mar. 24, 2011, now abandoned.

(51) Int. Cl. G06F 3/0484

(52) U.S. Cl. CPC G06F 3/04842

(57) ABSTRACT

An approach is provided for enabling a user to obtain additional information pertaining to a set of media content that is currently being presented to the user. According to this approach, a media access device: (a) accesses a set of media content and some context information pertaining to the media content: (b) provides the media content to a presentation device for presentation to a user; (c) generates a context message based upon the context information; and (d) sends the context message to a receiving device being used by the user. Using the information in the context message, the receiving device provides the user with additional information relevant to the media content being presented. By sending the context message to the receiving device, the media access device makes it much easier and more convenient for the user to access additional information relevant to the media content.

### BACKGROUND

There exist today many electronic devices that are used for entertainment and information gathering purposes. These electronic devices include media devices that obtain media content via cable, satellite, the Internet, etc., and stream the media content to a presentation device for presentation to a user. Examples of media devices include set top boxes, digital video recorders, and video streaming devices (e.g. Apple TV, Roku, some gaming consoles, etc.). Electronic devices that are used for entertainment and information gathering purposes also include a variety of other devices, such as for example, laptop and desktop computers, tablets, notebooks, and smart phones. These devices are often used to watch streaming videos, listen to music, chat with friends, engage in social networking, shop, and generally surf the Internet.

Many users often use several of these devices concurrently. For example, while watching a movie streamed by a video streaming device, a user may use a tablet or smart phone to text a friend, surf the web, check email, online chat, etc. A user may also use one type of device to enhance the experience of the other type of device. For example, while watching a show streamed by a video streaming device, a user may find a topic discussed in the show to be of particular interest. Using a computer, notebook, or tablet, the user may perform an online search on that topic, and then navigate to a site that has additional information on the topic. Thus, by using multiple devices concurrently, a user can enhance the overall entertainment and learning experience.

Currently, in order to obtain additional information pertaining to something being presented in a set of media content, a user has to exert a significant amount of effort. In the above example of obtaining more information on a particular topic, the user has to: (1) navigate to a search site; (2) formulate and type in some search terms; (3) review a set of search results; and (4) navigate to a site where more information on the topic is located. If the selected site does not have the information desired by the user, the user has to review the search results again and navigate to another site. The user may have to repeat this process several times before finding the precise information he/she desires. As can be seen, this process can be tedious and inconvenient. Even if the user is able to eventually find the information for which he/she is searching, the overall experience is not as pleasant or as convenient as it could be.

### BRIEF DESCRIPTION OF THE DRAWING(S)

FIG. 1 shows a block diagram of a system in which one embodiment of the present invention may be implemented.

FIG. 2 shows a block diagram of a device that can be used to implement a media access device and a receiving device, in accordance with one embodiment of the present invention.

FIG. 3 shows a flow diagram illustrating the operation of a media access device, in accordance with one embodiment of the present invention.

FIG. 4 shows a flow diagram illustrating the operation of a receiving device, in accordance with one embodiment of the present invention.

### DETAILED DESCRIPTION OF EMBODIMENT(S)

### Overview

In accordance with one embodiment of the present invention, an approach is provided for enabling a user to easily and conveniently obtain additional information pertaining to a set of media content that is currently being presented to the user. According to this approach, a media access device accesses a set of media content as well as some context information pertaining to the media content. For purposes of the present invention, the media content may be any type of content that can be presented to a user, including but not limited to video-only content (e.g. pictures, slideshows, graphics, text, etc.), audio-only content (e.g. music, speech, etc.), audio/visual content, generally referred to as video content (e.g. movies, shows, live events, etc.), etc. The context information may be any information relating to the media content. For example, the context information may include some basic information about the media content (e.g. title, author/creator, director, actors(s), synopsis, etc.) as well as some other information (e.g. an address to a site at which additional information about the media content can be obtained). The context information may pertain to the set of media content as a whole or just to a particular portion or aspect of the media content.

Upon accessing the media content, the media access device provides the media content to a presentation device for presentation to a user. The presentation device may, for example, be a television, a stereo system, etc. While the media content is being presented to the user, the media access device generates a context message based upon the context information. The media access device then sends the context message to a receiving device being used by the user that is capable of consuming the context message. Examples of a receiving device include but are not limited to a tablet, a smartphone, a laptop or desktop computer, a notebook, etc. Using the information in the context message, the receiving device provides the user with additional information relevant to the media content being presented. This additional information is provided to the user while the user is experiencing the media content on the presentation device. Thus, the additional information helps to enhance the user's enjoyment of the media content. By sending the context message to the receiving device, the media access device is in effect bridging the user's experience of the media content on the presentation device with the user's use of the receiving device to provide an overall integrated experience. By providing this bridge, the media access device makes it much easier and more convenient for the user to access additional information relevant to the media content.

To illustrate how this approach may be used advantageously, reference will be made to the above example in which the user wishes to obtain additional information pertaining to a topic that is being discussed in a set of media content. According to the approach, the media access device may access (along with the media content) some context information pertaining to the topic discussed in the media content. The context information may include, for example, a summary of the topic, as well as an address to a site at which detailed information on the topic can be obtained.

The media access device provides (e.g. streams) the media content to a presentation device for presentation to a user. The media access device also generates a context message that contains the summary information and the address of the site. When the presentation of the media content reaches a point at which the topic is about to be discussed, the media access device sends the context message to a receiving device. In turn, the receiving device uses the information in the context message to provide additional information on the topic to the user. Specifically, the receiving device may display the summary information to the user. In addition, the receiving device may display a link to the site that contains more detailed information on the topic. Should the user invoke the link, the receiving device navigates to the site and obtains additional information on the topic for the user. This is done while the topic is being discussed in the media content. Thus, there is a nexus between the media content that is being presented on the presentation device and the additional information that is provided to the user by the receiving device.

With this approach, the user is no longer required to perform a search on the topic, review search results, select one of various possible links, etc. Rather, the user simply has to review the additional information on the topic that is provided by the receiving device, and if the user is interested in obtaining more detailed information on the topic, the user can simply invoke the link provided by the receiving device. With this integration between the media content and the receiving device, additional information relevant to the media content can be easily and conveniently accessed, which can lead to enhanced enjoyment of the media content.

This approach can be particularly advantageous in a setting in which a set of media content is presented to multiple users, where each user has their own receiving device. In such a setting, the media access device would send the context message to each of the receiving devices. The user of each receiving device would then decide what to do with the additional information provided by their corresponding receiving device. Some users may choose to ignore the additional information, while others may review the information and even invoke a link to obtain more information. The main point is that by ignoring or fully exploiting the additional information provided by their receiving device, each user is in effect creating their own personalized experience of the media content. All the while, the media content on the presentation device is not changed. Thus, with this approach, each user is able have as full an experience of the media content as they want (with or without the additional information) without adversely affecting the experience of the media content by the other users.

The above discussion provides a general overview of an embodiment of the present invention. In the following sections, one or more possible implementations of the invention will be described in detail.

### System Overview

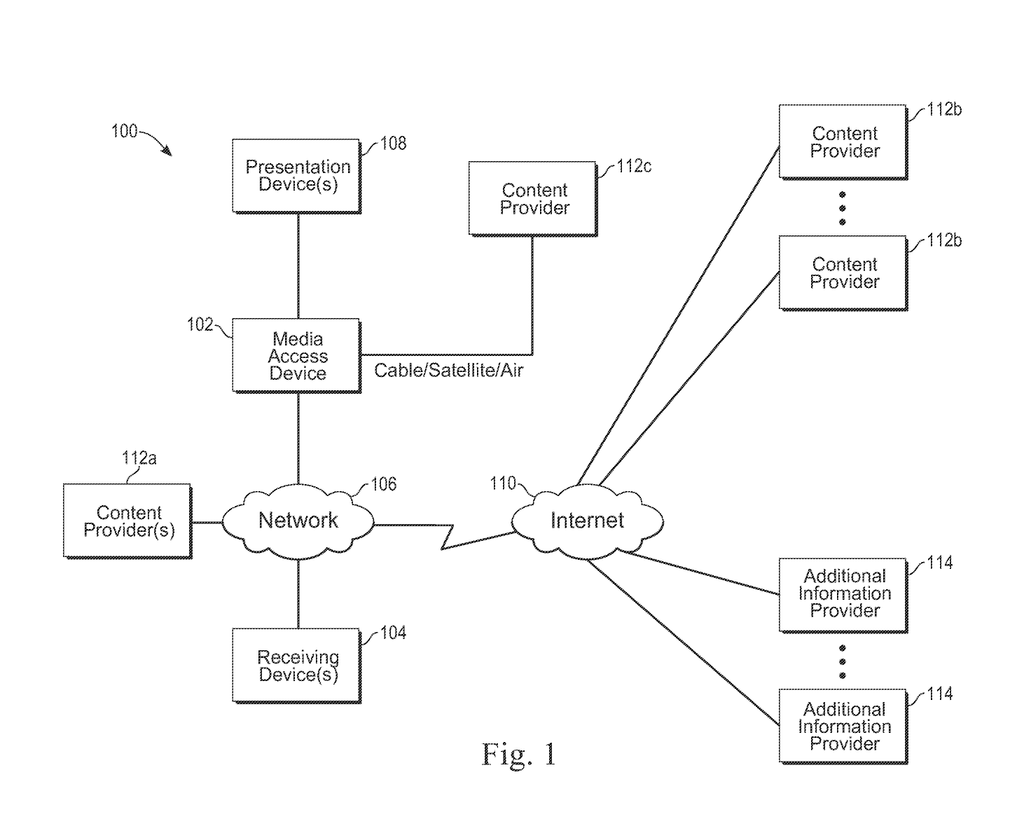

With reference to FIG. 1, there is shown a block diagram of a system 100 in which one embodiment of the present invention may be implemented. As shown, the system 100 comprises a media access device 102, one or more receiving devices 104, and one or more presentation devices 108. For purposes of the present invention, the media access device 102 may be any type of device capable of accessing media content and providing the media content to a presentation device 108 for presentation to one or more users. Examples of devices that may be used as the media access device 102 include but are not limited to set top boxes, digital video recorders, media streaming devices (e.g. Apple TV, Roku, various gaming consoles, etc.), computing devices (e.g. laptop or desktop computers, tablets, notebooks, smartphones, etc.), and various other devices. In addition to accessing media content and providing that media content to a presentation device 108, the media access device 102 also performs various other functions. In one embodiment, these include accessing a set of context information pertaining to a set of media content, generating a context message based at least partially upon the context information, and sending the context message to a receiving device 104 to enable the receiving device to provide additional information relevant to the media content to a user. These and other functions performed by the media access device 102 will be elaborated upon in later sections.

The media access device 102 is coupled to one or more presentation devices 108 (for the sake of simplicity, only one presentation device is shown). For purposes of the present invention, the presentation device 108 may be any type of device that is capable of presenting a set of media content to one or more users. Examples of a presentation device 108 include but are not limited to a television, a stereo system, a set of speakers, a monitor, etc. Overall, any device 108 or combination of devices that is capable of presenting or rendering audio, video, or audio/visual information to one or more users may be used as the presentation device 108. The media access device 102 may be communicatively coupled to the presentation device 108 via a wired connection (e.g. an HDMI cable, a set of composite cables, etc.), a wireless connection, or some other connection.

The media access device 102 is also coupled to one or more receiving devices 104 (for the sake of simplicity, only one receiving device is shown). For purposes of the present invention, a receiving device 104 may be any device capable of receiving one or more context messages from the media access device 102, and using the information in the one or more context messages to provide a user with additional information relevant to a set of media content. Examples of a receiving device include but are not limited to various computing devices such as laptop or desktop computers, tablets, notebooks, smartphones, etc. In the system of FIG. 1, the media access device 102 is coupled to the receiving device 104 via a network 106 (using a wired or wireless network connection). This is not required, however. If so desired, the media access device 102 may be coupled to the receiving device 104 via other types of connections including but not limited to a direct wired connection, a direct wireless connection (e.g. Bluetooth), or some other type of connection. The network 106 or the other types of connections may be used to send messages between the media access device 102 and the receiving device 104.

Network 106, for purposes of the present invention, may be any type of network. For example, network 106 may be a simple home Ethernet network implemented using a single wired/wireless router. Alternatively, network 106 may be a large scale corporate intranet network with high bandwidth capability and hundreds of interconnected devices, or something in between. In one embodiment, the network 106 has a connection to the Internet 110 so that devices coupled to the network 106 can access resources provided by remote devices.

In one embodiment, the media access device 102 accesses media content from one or more content providers 112a, 112b, 112c. For purposes of the present invention, the media access device 102 may access media content from any type of content provider via any type of connection/medium. In system 100, three different types of content providers are shown for illustrative purposes. A first type of content provider is a local content provider 112a. This type of content provider 112a is coupled to the local network 106, and provides media content to the media access device 102 via the network 106. As an alternative, the local content provider 112a may be coupled to the media access device 102 via a direct coupling (wired or wireless). Examples of this type of content provider 112a include but are not limited to laptop, desktop, tablet, and notebook computers as well as other devices that have media content stored on them, and that are capable of streaming the media content to the media access device 102. A second type of content provider is a remote content provider 112b. This type of content provider is accessed by the media access device 102 through the network 106 and the Internet 110. Examples of this type of content provider 112b include but are not limited to remote media streaming servers and cloud servers. A third type of content provider is an external content provider 112c that provides media content via a medium such as cable, satellite, or air. Examples of these content providers include cable service providers, satellite service providers, and local broadcasters. For purposes of the present invention, the media access device 102 may access media content from these and other types of content providers.

In one embodiment, in addition to accessing media content, the media access device 102 also accesses context information from the content providers 112 (the various types of content providers will be referenced collectively using reference number 112). This context information is information pertaining to the media content that is obtained from a content provider 112. For purposes of the present invention, the context information may be any information relating to the set of media content, and the context information may relate to the media content as a whole, or to just a particular portion or aspect of the media content. For example, the context information may be general information (e.g. title, author/creator, director, actor(s), synopsis, etc.) about the media content, or information relating to a specific scene in the media content, or information relating to a particular item or person shown in a particular scene, or information relating to a piece of music being played in the scene or a particular topic discussed in the scene, etc. The context information may also include an address (or information from which an address can be derived) to a site 114 at which additional information can be obtained about the media content or about a particular aspect or portion of the media content. Using the context information, the media access device 102 generates a context message, and sends the context message to a receiving device 104 to enable the receiving device to provide additional information relevant to the media content to a user. The operation of the media access device 102 will be elaborated upon in a later section.

### Media Access Device and Receiving Device Implementation

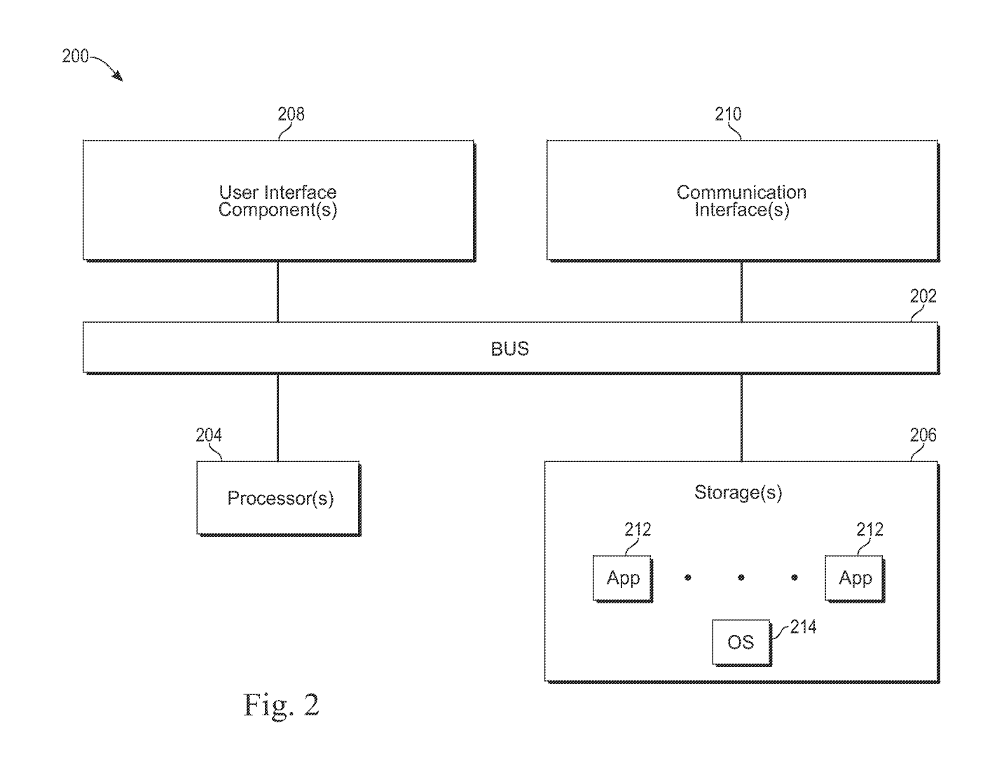

As made clear in the above discussion, the media access device 102 and the receiving device 104 are, in one embodiment, separate devices. Nonetheless, in accordance with one embodiment of the present invention, both may be implemented using devices with similar architectures. With reference to FIG. 2, there is shown a block diagram of a device 200 that can be used to implement both the media access device 102 and the receiving device 104 (note: even if both are implemented using a device 200 such as that shown in FIG. 2, they would still be implemented as two separate devices).

Device 200 includes a bus 202 for facilitating information exchange, and one or more processors 204 coupled to bus 202 for executing instructions and processing information. Device 200 also includes one or more storages 206 (also referred to herein as computer readable storage media) coupled to the bus 202. Storage(s) 206 may include any and all types of storages that may be used to carry out computer processing. For example, storage(s) 206 may include main memory (e.g. random access memory (RAM) or other dynamic storage device), cache memory, read only memory (ROM), permanent storage (e.g. one or more magnetic disks or optical disks), as well as other types of storage. The various storages 206 may be volatile or non-volatile. Common forms of computer readable storage media include, for example, a floppy disk, a flexible disk, hard disk, magnetic tape, or any other magnetic medium, a CD-ROM, DVD, or any other optical storage medium, punchcards, papertape, any other physical medium with patterns of holes, a RAM, a PROM, and EPROM, a FLASH-EPROM, any other memory chip or cartridge, or any other storage medium from which a computer can read.

As shown in FIG. 2, storage(s) 206 store at least several sets of executable instructions, including an operating system 214 and one or more applications 212. The processor(s) 202 execute the operating system 214 to provide a platform on which other sets of software may operate, and execute one or more of the applications 212 to provide additional, specific functionality. Depending on whether the device 200 is implementing the media access device 102 or the receiving device 104, the operating system 214 and the applications 212 will likely differ. That is, when the device 200 is used to implement the media access device 102, there will be one operating system 214 and one set of applications 212, and when the device 200 is used to implement the receiving device 104, there will likely be a different operating system 214 and a different set of applications 212.

In one embodiment, where the device 200 is used to implement the media access device 102, the functionality of the media access device 102 described herein is derived by having the processor(s) 202 execute one or more of the applications 212. These applications 212 will dictate the manner in which the media access device 102 processes context information, generates context messages, sends context messages, etc. These applications 212 may be content provider specific. Thus, the processor(s) 202 may execute one application 212 when interacting with one content provider 112 and another application 212 when interacting with another content provider 212.

Where the device 200 is used to implement the receiving device 104, the functionality of the receiving device 104 described herein is derived by having the processor(s) 202 execute one or more of the applications 212. These applications 212 will dictate the manner in which the receiving device 104 processes the context messages from the media access device 102. These applications 212 will also dictate any additional functionality provided by the receiving device 104.

The device 200 further comprises one or more user interface components 208 coupled to the bus 202. These components 208 enable the device 200 to receive input from and provide output to a user. On the input side, the user interface components 208 may include, for example, a keyboard/keypad having alphanumeric keys, a cursor control device (e.g. mouse, trackball, touchpad, etc.), a touch sensitive screen, one or more remote control sensors for receiving signals from a remote control, a microphone for receiving voice commands, etc. On the output side, the components 208 may include a graphics interface (e.g. a graphics card) and an audio interface (e.g. sound card) for providing video and audio output. The user interface components 208 may further include a display, a set of speakers, etc., for presenting the audio and video information to a user. In one embodiment, the one or more applications 212 executed by the processor(s) 204 may provide a software user interface that takes advantage of and interacts with the user interface components 208 to receive input from and provide output to a user. This software user interface may, for example, provide a menu that the user can navigate using one of the user input devices mentioned above. Depending on whether the device 200 is used to implement the media access device 102 or the receiving device 104, the actual user interface components 208 included in the device 200 may differ.

In addition to the components set forth above, the device 200 further comprises one or more communication interfaces 210 coupled to the bus 202. These interfaces 210 enable the device 200 to communicate with other components. The communication interfaces 210 may include, for example, a network interface (wired or wireless) for enabling the device 200 to send messages to and receive messages from the network 106. The communication interfaces 210 may also include a cable interface for enabling the device 200 to communicate via a cable connection, a satellite interface for receiving signals from a satellite dish, and an antenna and tuner for enabling the device 200 to receive signals through the air. The communications interfaces 210 may further include a wireless interface (e.g. Bluetooth) for communicating wirelessly with nearby devices, and a wired interface for direct coupling with a compatible local device. Furthermore, the communications interfaces 210 may include a 3G interface for enabling the device to access the Internet 110 without using network 106. These and other interfaces may be included in the device 200. As with the user interface components 208, depending on whether the device 200 is used to implement the media access device 102 or the receiving device 104, the actual communication interfaces 210 included in the device 200 may differ.

In the above example, the functionalities of the media access device 102 and the receiving device 104 are described as being software implemented. That is, the functionalities are derived by having the processor(s) 202 execute one or more sets of software. While this is one possible implementation, it is not the only one. If so desired, the functionalities of the media access device 102 and the receiving device 104 may be hardware implemented using, for example, one or more devices (e.g. a programmable logic array) having an array of elements, including logic elements, wherein the elements are programmed/configured to implement the technique(s) described herein. As an alternative, the media access device 102 and the receiving device 104 may be hardware implemented by way of another device such as an application specific integrated circuit (ASIC) having elements, including logic elements, that are constructed/configured to implement the technique(s) described herein. Overall, the media access device 102 and the receiving device 104 may be hardware implemented using any number of devices with elements, including logic elements, that are constructed/configured to implement the technique(s) described herein. These and other implementations are within the scope of the present invention.

### General Operation

The above discussion describes the components of a system 100 in which one embodiment of the present invention may be implemented. With reference to the system diagram of FIG. 1, the operation of the system 100, in accordance with one embodiment of the present invention, will now be described. In the following discussion, for the sake of illustration, it will be assumed that the media access device 102 and the receiving device 104 are coupled via network 106. It is also assumed that the network 106 takes the form of a packet switched, local area network (LAN) that is implemented using a router with the ability to implement a publish/subscribe protocol and support unicasting, multicasting, and broadcasting of packets.

### Communication Setup

In one embodiment, the media access device 102 and the receiving device 104 exchange messages using a publish/subscribe protocol. Before messages can be exchanged using this protocol, some communication setup needs to be performed. The actual setup performed will depend upon whether unicasting or multicasting is used.

If multicasting is used, the media access device 102 participates in the publish/subscribe protocol as follows. The media access device 102 initiates the setup by interacting with the router to: (1) advertise the context messaging service as a service that is available on the network 106; and (2) set up a multicast address. This multicast address is the address to which the media access device 102 will send context messages. When a receiving device 104 joins the network 106 and interacts with the router, it sees the context messaging service as a service to which it can subscribe. When the receiving device 104 subscribes to or registers for the service, its address is added by the router to a list of addresses associated with the multicast address. Multiple receiving devices 104 may subscribe to the context messaging service; thus, multiple receiving device addresses may be associated with the multicast address. When the media access device 102 sends a context message to the multicast address, the router forwards the context message to each of the receiving device addresses associated with the multicast address. In this manner, the media access device 102 is able to publish a context message to each of the subscribing receiving devices 104. If security is a concern, the media access device 102 may encrypt the context messages, and during registration, each receiving device 104 may be required to carry out a check-in procedure with the media access device 102 to receive the decryption key.

If unicasting is used, the media access device 102 participates in the publish/subscribe protocol in a slightly different manner. Initially, the media access device 102 interacts with the router to advertise the context messaging service as a service that is available on the network 106. When a receiving device 104 joins the network 106 and interacts with the router, it sees the context messaging service as a service to which it can subscribe. When a receiving device 104 sends a request to the router to subscribe to the service, the router forwards the request to the media access device 102. The media access device 102 then interacts with the receiving device 104 to set up a communication channel that will be used to send context messages to that receiving device 104. If another receiving device 104 subscribes to the context messaging service, the media access device 104 will interact with that receiving device 104 to set up a separate communication channel that will be used to send context messages to that receiving device 104. Thus, the media access device 102 may set up multiple communication channels, one for each registered receiving device 104. When it comes time to send a context message, the media access device 102 will send multiple copies of the context message, one to each receiving device 104 on its corresponding communication channel. If security is a concern, the media access device 102 may encrypt the context messages, and during registration, each receiving device 104 may be required to carry out a check-in procedure with the media access device 102 to receive the decryption key.

As an alternative to multicasting and unicasting, the media access device 102 may simply instruct the router to broadcast its context messages. This will cause all of the devices coupled to the network 106 to receive all of the context messages.

In the various manners described above, communication may be established between the media access device 102 and the one or more receiving devices 104. In the following discussion, when a context message is said to be sent from the media access device 102 to a receiving device 104, it should be understood that the context message may be sent using multicasting, unicasting, broadcasting, or perhaps even some other methodology (e.g. push notification, polling, etc.).

### Regular Operation

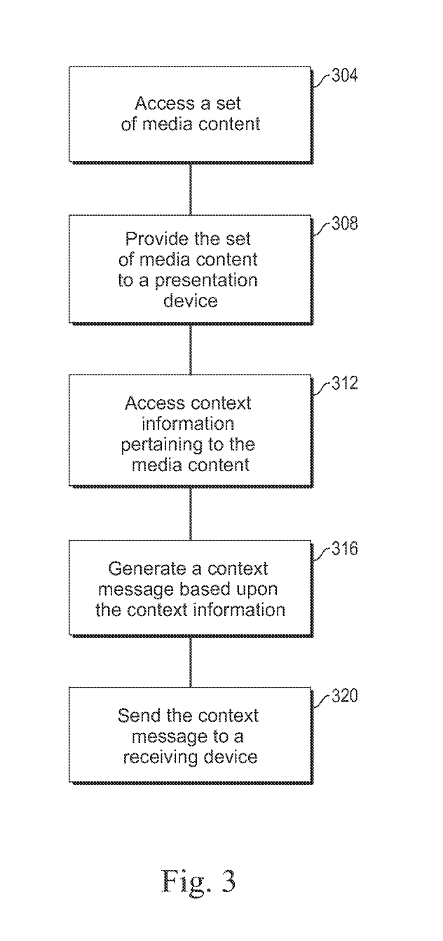

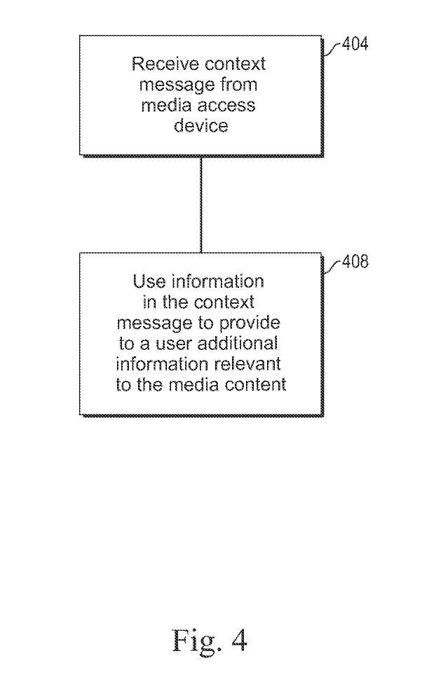

With reference to the flow diagrams shown in FIGS. 3 and 4, and the system diagram of FIG. 1, the regular operation of system 100, in accordance with one embodiment of the present invention, will now be described. FIG. 3 illustrates the operation of the media access device 102, while FIG. 4 illustrates the operation of a receiving device 104.

Media Access Device Operation

In one embodiment, the operation of the media access device 102 is initiated by a user selecting (using a user interface provided by the media access device 102) a particular set of media content for presentation. As noted previously, the media content may be video-only content (e.g. pictures, slideshows, graphics, text, etc.), audio-only content (e.g. music, speech, etc.), audio/visual content, referred to herein as video content (e.g. movies, shows, live events, etc.), etc. In response to the user selection, the media access device 102 accesses (block 304) the media content. The media access device 102 may access the media content from its own storage if the media content is already stored therein, or it may access the media content from one of the content providers 112. If the media content is accessed from one of the content providers 112, the media access device 102, in one embodiment, stores the media content in its own storage as the media content is received from the content provider 112. The media access device 102 may wait until a sufficient portion of the media content is stored (i.e. buffered) before it begins providing the media content to a presentation device 108.

At some point, the media access device 102 begins providing (block 308) the media content to one or more presentation devices 108 for presentation to one or more users. In one embodiment, the media access device 102 provides the media content by streaming it to the presentation device 108.

In addition to accessing the media content, the media access device 102 also accesses (block 312) one or more sets of context information relating to the media content (if such context information is provided). This context information may be included with the media content (e.g. embedded within the media content with special delineators), in which case the media access device 102 extracts the context information from the media content. Alternatively, the context information may be provided on a separate channel from the media content, in which case the context information is received/accessed in parallel with the media content. Like the media content, the context information may also be stored by the media access device 102.

As noted previously, the context information may pertain to the media content as a whole, or just to a particular portion of the media content. In one embodiment, if a set of context information relates to a particular portion of the media content, then the context information may include correlation information that enables the media access device 102 to correlate the context information with the portion of the media content with which it relates. For example, if the context information relates to a scene that is at the twenty one minute mark of a movie, the context information may include correlation information indicating that the context information is associated with a scene that is at the twenty one minute mark of the movie. This information allows the media access device 102 to synchronize the context information with the media content, as will be elaborated upon in a later section. If the context information is not related to any particular portion of the media content but rather is related to the media content as a whole, then the context information may not contain any correlation information.

During the course of streaming a set of media content to the presentation device 108, the media access device 102 may receive/access zero, one, or more sets of context information relating to the media content. During the times when no sets of context information are received/accessed, the media access device 102 just streams the media content to the presentation device 108. However, when a set of context information is received/accessed, the media access device 102 proceeds to generate (block 316) a context message based at least partially upon the context information. In generating the context message, the media access device 102 may perform as little or as much processing as desired. For example, the media access device 102 may simply take the context information, format it, and encapsulate it within a context message. Alternatively, the media access device 102 may perform some processing on the context information to obtain or generate some additional information, and encapsulate this additional information (perhaps along with the context information) in the context message. For example, using the context information, the media access device 102 may generate a uniform resource locator (URL) for a site 114 at which additional information may be obtained, and include this URL in the context message. The media access device 102 may go even further to navigate to the site 114 (e.g. via network 106 and Internet 110), obtain the additional information, and include the additional information in the context message. These and other operations may be performed. For purposes of the present invention, the media access device 102 may process, manipulate, and use the context information in any desired manner, and may carry out any type of processing in generating the context message.

After a context message is generated, it is sent (block 320) by the media access device 102 to one or more receiving devices 104. The context message may be sent in the form of one or more packets. In one embodiment, as part of sending the context message, the media access device 102 determines whether the context information used to generate the context message was associated with a particular portion of the media content. This may be done, for example, by determining whether the context information had any correlation information in it that indicated that the context information was associated with a particular portion of the media content. If the context information was not associated with any particular portion of the media content, then the media access device 102 may send the context message to the receiving device 104 at any time. However, if the context information was associated with a particular portion of the media content, then the media access device 102, in one embodiment, waits until that particular portion of the media content is being presented or is about to be presented to the user by the presentation device before sending the context message to the receiving device 104. By timing the sending of the context message in this manner, the media access device 104 helps to ensure that when the receiving device 104 uses the information in the context message to provide additional information to the user, the additional information is provided to the user at a time that the particular portion of the media content is being presented to the user. That way, there is a nexus between the content that the user is currently experiencing and the additional information that is provided by the receiving device 104. Hence, the media content and the additional information are synchronized.

In the manner described above, the media access device 102 may receive/access one or more sets of context information while streaming a set of media content to a presentation device 108, and in response, may generate and send one or more context messages to a receiving device 104.

Receiving Device Operation

The receiving device 104 listens for context messages from the media access device 102. When a context message is received (block 404), the receiving device 104 processes the message and extracts information therefrom. Using (block 408) the information extracted from the context message, the receiving device 104 provides to a user some additional information relevant to the media content that the user is currently experiencing on the presentation device 108. What additional information is provided, and the manner in which the additional information is obtained and presented, will depend upon the information itself and the processing capability of the receiving device. For example, the context message may include some text as well as an address (e.g. a URL) to a site at which additional information relevant to the media content may be obtained. Using this information, the receiving device 104 may display the text and a link to the site, which may be invoked by the user to navigate to the site. Alternatively, the receiving device 104 may automatically navigate to the site, obtain the additional information, and display both the text and the additional information to the user. Also, the information from the context message may not include a URL but may contain information from which a URL may be constructed. The receiving device 104 may construct the URL, navigate to the site, obtain the additional information, and display the additional information to the user. These and many other operations may be performed by the receiving device 104 using the information from the context message. Overall, for purposes of the present invention, the receiving device 104 may process, manipulate, and use the information from the context message in any desired manner, may carry out any type of processing in obtaining/generating the additional information relevant to the media content, and may present the additional information to the user in any desired manner.

Context Message Format

In one embodiment, the context message that is sent from the media access device 102 to the receiving device 104 is formatted as a list of parameters and associated values. A sample list of parameters is provided below. It should be noted that this list is provided for illustrative purposes only and should not be interpreted to be limiting in any way.

version=“ ”

messageType=“ ”

message=“ ”

mediaID=“ ”

mediaTitle=“ ”

mediaType=“ ”

artist=“ ”

description=“ ”

address=“ ”

imageAddress=“ ”

priority=“ ”

The “version” parameter indicates the version of software that is currently executing on the media access device 104. Depending on the version, the receiving device 104 may have to process the context message differently. The “messageType” parameter indicates the type of the context message. In one embodiment, the possible message types include “media” (this type of message contains information pertaining to a set of media content), “log” (this type of message includes a system log message; may be used for system administration or debugging), and “message” (this type of message is an actual message or alert). The “message” parameter contains a message (e.g. text) that is to be displayed to the user.

The “mediaID” and “mediaTitle” parameters identify the media content to which the context message pertains. The “mediaID” is an ID that uniquely identifies the set of media content within a particular system (e.g. the media content may be item number 35949 in a particular storage system). The “mediaTitle” is the name of the media item (e.g. the name of a song or movie), which may not be unique. The “mediaType” parameter indicates the type of the media content. In one embodiment, the possible media content types include movie, song, trailer, live broadcast, and pictures. Other media types may be added, if so desired. The “artist” parameter specifies the performer of the media content; thus, if for example the media content is a song, the “artist” parameter indicates the name of the person or band that is performing the song. The “description” parameter provides a description of the media content. This description, which may be in the form of text, may be brief or fairly involved.

The “address” parameter provides an address to a site at which additional information pertaining to the media content may be obtained. The address may be in the form of a URL or some other form. The “imageAddress” parameter provides an address to a site at which an image for the media content can be found. If, for example, the media content is a song, the “imageAddress” may point to a site at which an album cover for the song can be found. The “priority” parameter indicates a priority for the context message. The receiving device 104 can use this priority parameter to determine the manner in which it will handle and prioritize the context message.

The above list is just an example of a possible format for the context message. Other formats may be used, and parameters may be added or removed from the list as desired. Such alterations are within the scope of the present invention.

### Sample Applications

The above discussion describes the general operation of the system 100, in accordance with one embodiment of the present invention. To illustrate the flexibility and versatility of the present invention, several specific applications of the approach described herein will now be discussed.

### Application 1

The media access device 102 may access a song via cable, satellite, or air from a content provider 112c, and stream it to a presentation device 108 (e.g. a stereo system) to be played to a user. The media access device 102 also accesses some context information from the content provider 112c that includes some basic information about the song (e.g. song title, artist, etc.) as well as an address to a music site at which the song can be purchased. The media access device 102 generates a context message that encapsulates the context information, and sends the context message to a receiving device 104. The receiving device 104 displays the basic information about the song to the user as well as a link to the music site. Should the user like the song, the user can invoke the link to navigate to the music site, purchase the song from the site, and cause the song to be downloaded to the receiving device 104.

As a slight variation, the context information may include the basic information about the song as well as an address to a site at which the lyrics to the song may be obtained. When the receiving device 104 receives the context message, the receiving device 104 extracts the basic information about the song and the address to the site at which the lyrics for the song can be obtained. The receiving device 104 then navigates to the site, obtains the lyrics, and shows the basic information about the song and the lyrics to the user.

### Application 2

The media access device 102 may access a movie trailer from a remote content provider 112b, and stream it to a presentation device 108 (e.g. a television) to be played to a user. The media access device 102 also accesses some context information from the content provider 11b that includes some basic information about the movie (e.g. movie title, director, actors, synopsis, etc.) as well as an address to a site at which tickets for the movie can be purchased. The media access device 102 generates a context message that encapsulates the context information, and sends the context message to a receiving device 104. The receiving device 104 displays the basic information about the movie to the user as well as a link to the ticket purchasing site. Should the user wish to see the movie after watching the trailer, the user can invoke the link to navigate to the ticket purchasing site and purchase tickets to the movie therefrom.

As a slight variation, the context information may include just the basic information about the movie. When the receiving device 104 receives the context message, the receiving device 104 uses the basic information about the movie to access the proper pages from several sites. For example, the receiving device 104 navigates to a movie review site where reviews for various movies can be found. Using the information about the movie, the receiving device 104 navigates to the page within the movie review site that contains a review for that movie. This review is shown in a first portion of the receiving device's display. The receiving device 104 also navigates to a social media site where various users are discussing various movies. Using the information about the movie, the receiving device 104 navigates to the page within the social media site where this particular movie is being discussed. This discussion is shown in a second and different portion of the receiving device's display.

If the trailer is for a movie that has not been released yet, the context information may further contain a date for the opening night of the movie. The receiving device 104 may store this date in a calendar that is maintained for the user so that the user can be reminded.

### Application 3

The media access device 102 may access a show from a content provider 112 and stream it to a presentation device 108 (e.g. a television) to be played to a user. The show may contain the show's content as well as one or more commercials. In a particular scene (which may be part of the show or a commercial), a certain item is shown (or a certain song is played). The media access device 102 accesses some context information pertaining to that scene, and in particular, pertaining to that item (or that song). The context information may include a short description of the item (or song), a coupon for the item (or song), and an address to a site at which the item (or song) can be purchased. The media access device 102 generates a context message that encapsulates the context information, and sends the context message to a receiving device 104. The context message is sent while the item is being shown (or the song is being played) on the presentation device or shortly before that. The receiving device 104 displays the short description of the item (or song), the coupon, and a link to the site at which the item (or song) can be purchased. This information is shown to the user by the receiving device 104 while the item is being shown (or the song is being played) on the presentation device 108. Should the user like the item (or song), the user can invoke the link to navigate to the site and purchase the item (or song) from the site using the coupon.

### Application 4

The media access device 102 may access a sporting event, such as a baseball game, from a content provider 112, and stream it to a presentation device 108 (e.g. a television) for presentation to a user. At one point in the game, a particular player comes up to bat. The media access device 102 accesses some context information pertaining to that player. This context information (which in one embodiment is provided by the content provider) may include an address to the player's detailed statistics page. The media access device 102 generates a context message that encapsulates the context information, and sends the context message to a receiving device 104. The context message is sent while the player is batting or shortly before that. The receiving device 104 receives the context message and extracts the address to the player's statistics page therefrom. The receiving device 104 then navigates to the player's statistics page, obtains the player's statistical information, and presents it to the user. This information is shown to the user by the receiving device 104 while the player is batting, thereby enhancing the user's enjoyment of the baseball game.

### Application 5

The media access device 102 may access a sporting event, such as a football game, from a content provider 112, and stream it to a presentation device 108 (e.g. a television) for presentation to a user. At one point in the game, a noteworthy play, such as a touchdown, occurs. The media access device 102 accesses some context information pertaining to this play. This context information (which in one embodiment is provided by the content provider) may include an address to a site where a short recording of the play is stored. The media access device 102 generates a context message that encapsulates the context information, and sends the context message to a receiving device 104. The context message is sent shortly after the play has taken place. The receiving device 104 receives the context message and extracts therefrom the address to the site where the short recording of the play is stored. The receiving device 104 then navigates to the site, and shows the short recording of the play to the user. Effectively, this allows the receiving device 104 to show an “instant” replay of the play to the user.

### Application 6

The media access device 102 may access a movie from a content provider 112 and stream it to a presentation device 108 (e.g. a television) to be played to a user. While streaming the movie, the media access device receives some context information unrelated to the movie. For example, the context information may contain an alert indicating that another movie in the same genre as the current movie is now available for streaming. The media access device 102 generates a context message that encapsulates the context information, and sends the context message to a receiving device 104. Upon receiving the context message, the receiving device 104 displays the alert to the user.

As a slight variation, the context information may contain a notification of an event unrelated to the movie. For example, the media access device 102 may be coupled to a gaming device (not shown in FIG. 1) on which the user is playing a game, and the event may be that it is now the user's turn. In response to the context information, the media access device 102 generates a context message that encapsulates the context information, and sends the context message to a receiving device 104. Upon receiving the context message, the receiving device 104 displays the event notification to the user.

The above applications provide just a few examples of what can be achieved with the approach described herein. Many other applications are possible, and are within the scope of the present invention.

In the foregoing specification, embodiments of the present invention have been described with reference to numerous specific details that may vary from implementation to implementation. Thus, the sole and exclusive indicator of what is the invention, and is intended by the Applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1-25. (canceled)

26. A method, comprising:
receiving, at a first device, a context message associated with content being displayed on a display device separate from the first device; and
responsive to user interaction with the context message at the first device:
creating an item for an application program of the first device;
populating the application program item with data from the context message; and
storing the application program item as part of a data structure of the application program.

27. The method of claim 26, wherein the application program item is a calendar entry.

28. The method of claim 26, wherein the application program item is a reminder.

29. The method of claim 26, wherein the context message identifies a release date associated with the content being displayed on the first device.

30. The method of claim 26, further comprising performing the receiving, creating, populating and storing on a plurality of devices separate from the display device and from each other.

31. The method of claim 26, wherein the context message is received from a media access device separate from the first device and the display device.

32. The method of claim 26, wherein the content is an advertisement for a product having a release date identified in the context message.

33. The method of claim 26, wherein the content is a trailer for a movie having a release date identified in the context message.

34. An electronic device, the device including:
a receiver; and
a processor configured to execute program instructions to:
receive a context message associated with content being displayed on a display device separate from the electronic device; and
responsive to user interaction with the context message at the electronic device:
create an item for an application program of the electronic device;
populate data fields of the application program item from data of the context message; and
store the application program item as part of the data structure of the application program.

35. The electronic device of claim 34, wherein the application program item is a calendar entry.

36. The electronic device of claim 34, wherein the application program item is a reminder.

37. The electronic device of claim 34, wherein the context message identifies a release date associated with the content being displayed on the first device.

38. The electronic device of claim 34, where the processor is further configured to perform the receiving, creating, populating and storing on a plurality of devices separate from the display device and from each other.

39. The electronic device of claim 34, wherein the context message is received from a media access device separate from the first device and the display device.

40. The electronic device of claim 34, wherein the content is an advertisement for a product having a release date identified in the context message.

41. The electronic device of claim 34, wherein the content is a trailer for a movie having a release date identified in the context message.

42. A non-transitory machine-readable storage medium having program instructions, which when executed by a processor perform a method, the method comprising:
receiving, at a first device, a context message associated with content being displayed on a display device separate from the first device; and
responsive to user interaction with the context message at the first device:
creating an item for an application program of the first device;
populating data fields of the application program item from data of the context message; and
storing the application program item as part of the data structure of the application program.

43. The non-transitory machine-readable storage medium of claim 42, wherein the application program item is a calendar entry.

44. The non-transitory machine-readable storage medium of claim 42, wherein the application program item is a reminder.

45. The non-transitory machine-readable storage medium of claim 42, wherein the context message identifies a release date associated with the content being displayed on the first device.
